(19) United States
(12) Patent Application Publication
(10) Pub. No.: US 2015/0334928 A1
(43) Pub. Date: Nov. 26, 2015

(54) TRELLIS SYSTEM SUPPORT MEMBER AND HYDROPONIC TRELLIS SYSTEM INCLUDING SAME

(71) Applicant: Dale A. KORT, WALLED LAKE, MI (US)

(72) Inventor: Dale A. KORT, WALLED LAKE, MI (US)

(21) Appl. No.: 14/717,322

(22) Filed: May 20, 2015

Related U.S. Application Data
(60) Provisional application No. 62/001,288, filed on May 21, 2014.

(51) Int. Cl. A01G 9/12; A01G 31/02

(52) U.S. Cl. CPC A01G 9/126; A01G 31/02

(57) ABSTRACT

An annular support member is provided for use in connection with a hydroponic growing container. In one embodiment, the support member has a circular ring shape with a plurality of stake support recesses formed therein and arranged in spaced relation therearound, each of the recesses being configured to supportively receive an end portion of an elongated stake therein. The recesses may be formed either as blind holes which are closed on the bottom end thereof, or may be formed as through holes. The support member may also include a plurality of cylindrical collars, with each of the recesses formed inside one of the cylindrical collars. And a plurality of reinforcing webs interconnecting each of the cylindrical collars with adjacent portions of the respective walls. The support member may be provided as part of a modified bucket lid.

### CROSS-REFERENCE TO RELATED APPLICATIONS

This application is based upon, and claims the benefit of priority under 35 USC 119(e) from U.S. Provisional Patent Application No. 62/001,288, filed May 21, 2014. The entire contents of the priority application are incorporated by reference herein.

### BACKGROUND OF THE INVENTION

1. Field of the Invention

The present invention relates to a detachable support member which is suitable for use in plant-growing trellis systems, including hydroponics plant-growing trellis systems, and also relates to a trellis system including such support member. More particularly, the present invention relates to such a support member which can reliably support elongated stakes, that extend in a generally vertical direction, and that help to support plants that are being grown in a plant-growing system.

The support member can reliably support the elongated stakes, either in a hydroponic (fluid-based) growing environment or in a system using a solid growth medium such as soil.

2. Background Art

The use of vertical stakes or rods is a common, easy, and cost-effective method for trellising plants grown in dirt or soil, e.g., ends of the stakes are inserted into the ground, or into soil disposed in a bucket or other container, in relatively close proximity to plant(s) being grown in the ground or soil, and then parts of the plants may then be secured to portions of the stakes which extend upwardly out of the ground or soil. Hence, the soil functions together with the stakes to provide support for the plants as they grow.

The field of hydroponics pertains to a method of cultivating plants by growing them in liquid nutrient solutions rather than dirt or soil, and the recent explosive growth in the field of hydroponics has created a need for a sufficiently sturdy and reliable trellis system that can incorporate use of elongated members, such as stakes or rods. It would be advantageous to incorporate elongated stakes or rods in a hydroponic growing environment for supporting plant branches, limbs and vines. However, no such hydroponic trellis arrangement is currently available.

In conventional hydroponics growing containers/systems liquid is used as a growing medium, and therefore, there is nothing equivalent to a mass of soil or dirt in which ends of elongated stakes may be inserted for support. For example, although ends of the elongated stakes can be inserted into the hydroponic reservoir containing the nutrient solution and plant roots, the stake ends may cause damage to the plants, whereas with the nutrient solution being a liquid it does not provide the required stability for the stakes and plants supported by the stakes that is achieved by a mass of dirt or soil.

Some examples of patents and published applications relating either to the field of hydroponics generally, or to horticulture containers including plant supports include Mori, U.S. Pat. No. 4,662,106, Constance, U.S. Pat. No. 5,067,275, Smith, U.S. Pat. No. 6,393,764 and Washingon, US Application Publication 2014-0196365.

Since elongated stakes cannot currently be used in conventional hydroponic systems in a manner similar to how the stakes are used in conventional in-ground planting by being inserted into the ground, dirt, or soil, other, alternative support structures such as horizontal trellises, netting, helical coils, or tomato cages are used in hydroponics systems. These types of trellis systems are cumbersome, and make it difficult to move the plants or access the reservoir(s) to change the nutrient solution, which is typically done, at a minimum, on a weekly basis.

The present invention has been developed to overcome the drawbacks of existing hydroponic trellis systems, and to provide further benefits to the hydroponic botanist, farmer, gardener, or other grower.

An object of the present invention is to introduce a hydroponic trellis system using elongated stakes that is easy/convenient to use and inexpensive to manufacture, and allows for quality and efficient plant cultivation.

### BRIEF SUMMARY OF THE INVENTION

The present invention provides a new means and method of trellising plants grown in a hydroponic environment that provides considerable advantages over conventional trellis systems currently available in the field of hydroponics.

According to a first aspect of the present invention there is provided a support member which may be secured to a portion of a hydroponic growing apparatus, such as a hydroponic nutrient solution container, or a lid for such container.

The support member according to the present invention supports elongated stakes in a manner somewhat similar to conventional trellis systems currently used for potted plants or plants grown inside or outside in dirt/the ground. The support member according to the present invention has a plurality of “blind” recesses defined therein, e.g., in spaced relation around the periphery thereof, and into which ends of elongated stakes or rods may be inserted. Portions of the stakes extend vertically or upwardly from, and are stably supported by the support member and by the portion(s) of the trellising system to which the support member is secured.

With the elongated stakes being appropriately secured by the support member, the branches or limbs of a plant can be attached to and stably supported by the stakes using ties, string, wire or the like. Terminal end portions of the elongated stakes are inserted into the recesses in the support member, and because the support member is secured to portion(s) of the trellising system, it can stably support the elongated stakes such that they extend upwardly from the support member, in a manner similar to the elongated stakes which have ends thereof inserted into the dirt/soil of a potted plant, or to the elongated stakes which have ends thereof inserted into the ground in the outdoors.

Alternatively, it is possible to form the support member integrally together with another portion of the trellising system such as a container lid or nutrient reservoir.

For a more complete understanding of the present invention, the reader is referred to the following detailed description section, which should be read in conjunction with the accompanying drawings. Throughout the following detailed description and in the drawings, like numbers refer to like parts. The drawings herein are provided by way of illustration only, and are not intended to limit the scope of the present invention. It is to be understood that the invention may be embodied in various and alternative forms. The figures are not necessarily to scale, and some features may be exaggerated or minimized to show details of particular components.

### BRIEF DESCRIPTION OF THE DRAWINGS

FIG. 1A is a perspective view of an annular support member according to an exemplary embodiment of the present invention, seen from an upper side thereof.

FIG. 1B is a perspective view of the support member of FIG. 1A, shown inverted and seen from a lower side thereof.

FIG. 1C is a cross-sectional view of the support member of FIG. 1A, taken along the line 1C-1C.

FIG. 2A is an exploded view of a trellis system including the support member of FIG. 1A, a root ball receptacle with basket, and a plurality of elongated stakes.

FIG. 2B is a perspective view of a nutrient reservoir bucket with a root ball receptacle disposed over the bucket.

FIG. 2C is a perspective view of the nutrient reservoir bucket and root ball receptacle of FIG. 2B, also showing the annular support member of FIG. 1A placed on top of a rim portion of the root ball receptacle.

FIG. 3 is perspective view of a root ball receptacle.

FIG. 4 is a perspective view of a root ball receptacle and annular support member.

### DETAILED DESCRIPTION OF ILLUSTRATIVE EMBODIMENTS

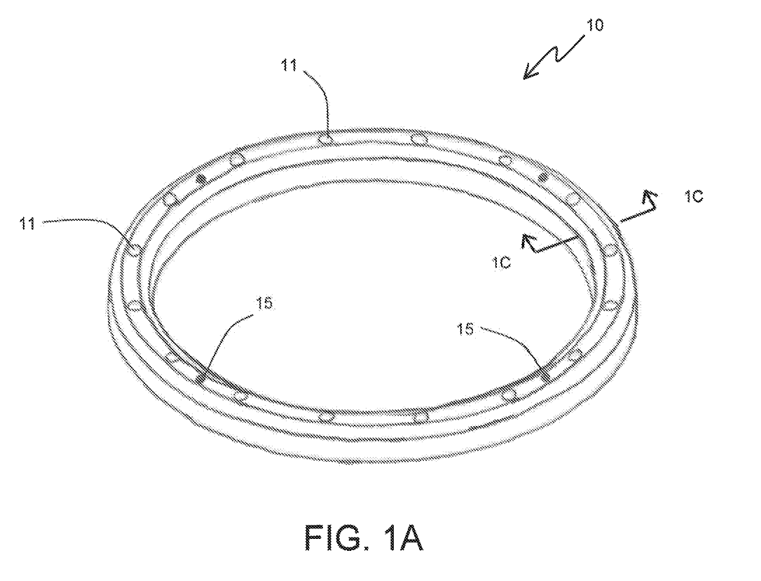

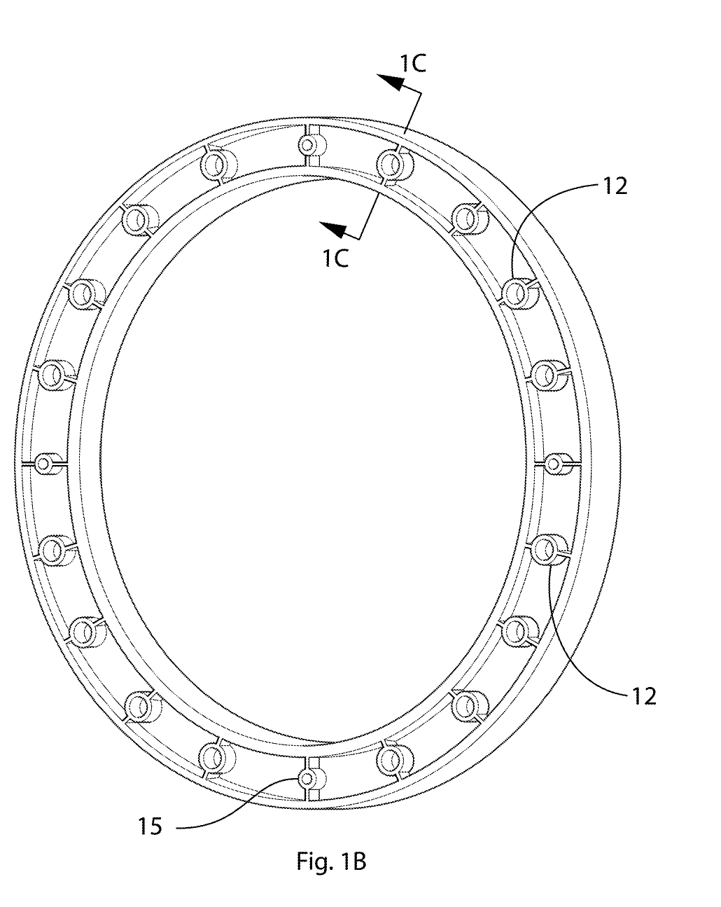

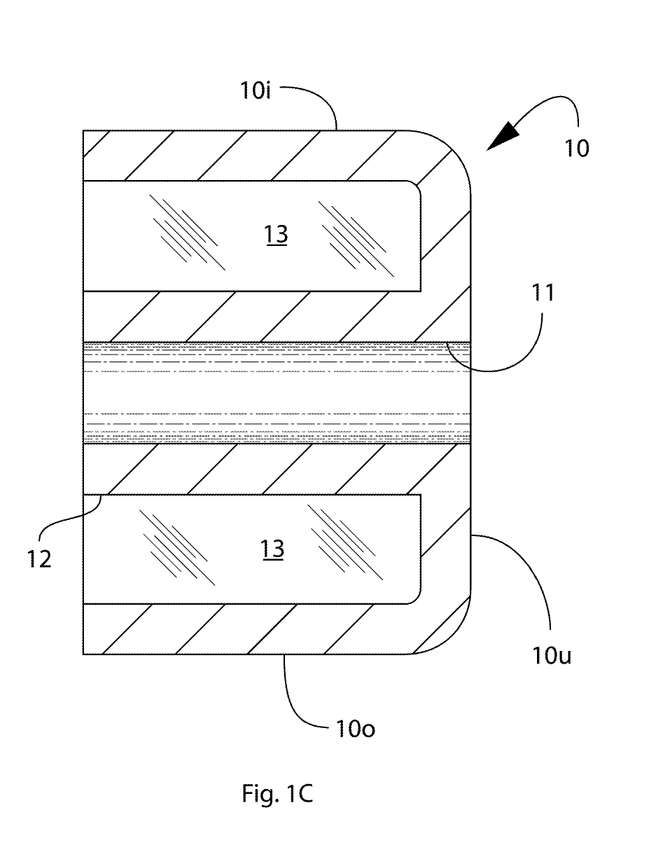

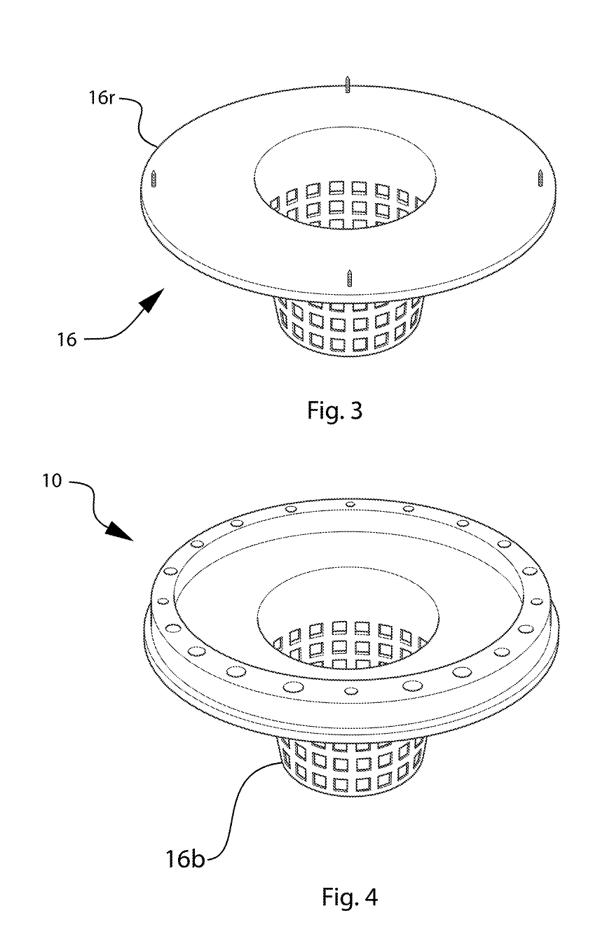

With reference to the drawings, particularly FIGS. 1A, 1B, and 2A-4, an exemplary embodiment of an annular support member 10 (also referred to as a support member 10) according to the present invention is shown. In the depicted embodiment, the support member 10 has a circular ring shape with a plurality of stake support recesses 11 formed therein and arranged in spaced relation around the periphery thereof. Each of the recesses 11 is configured to supportively receive an end portion 14a of an elongated stake 14 therein, where such stake is used for helping to support a plant growing inside of the bucket and the basket 16b formed in a modified bucket lid 16.

The plurality of recesses 11 may be formed as “blind” holes, which are closed on the bottom end thereof, or alternatively, may be formed as through holes. In one embodiment, the support member 10 may be substantially solid, with the recesses 11 and the fastening holes 15 formed substantially vertically therethrough.

If holes or recesses 11 are formed in a support member extending completely through the support member 10, the terminal ends 14a of the stakes 14 may pass completely through the support member and come to rest on top of the modified bucket lid 16.

In contrast, if bottomed recesses are formed in the support member or in a lower one of two support members that are connected together, the end portions 14a of the stakes 14 engage the bottoms of the recesses 11, and do not pass completely through the support member. Either one of the above arrangements for the recesses is acceptable in the practice of the present invention.

In another embodiment and as illustrated in the drawings, the support member 10 may have hollow spaces formed therein to conserve material, and in this embodiment, the support member 10 includes a substantially vertical radially inner wall 10i, a substantially vertical radially outer wall 10o, and a substantially horizontal upper wall 10u interconnecting the inner and outer walls.

In the depicted embodiment, each of the recesses 11 is surrounded by an integrally molded cylindrical collar 12 for strength and reinforcement. In this embodiment, the support member 10 also includes reinforcing webs 13 interconnecting each of the cylindrical collars with adjacent portions of the respective walls.

The support member 10 also has a plurality of fastening holes 15 formed therein to receive threaded shaft portions of fastening members 18 therein, as will be further described below. The structure surrounding the fastening holes 15 is similar to the structure described above in connection with the recesses 11.

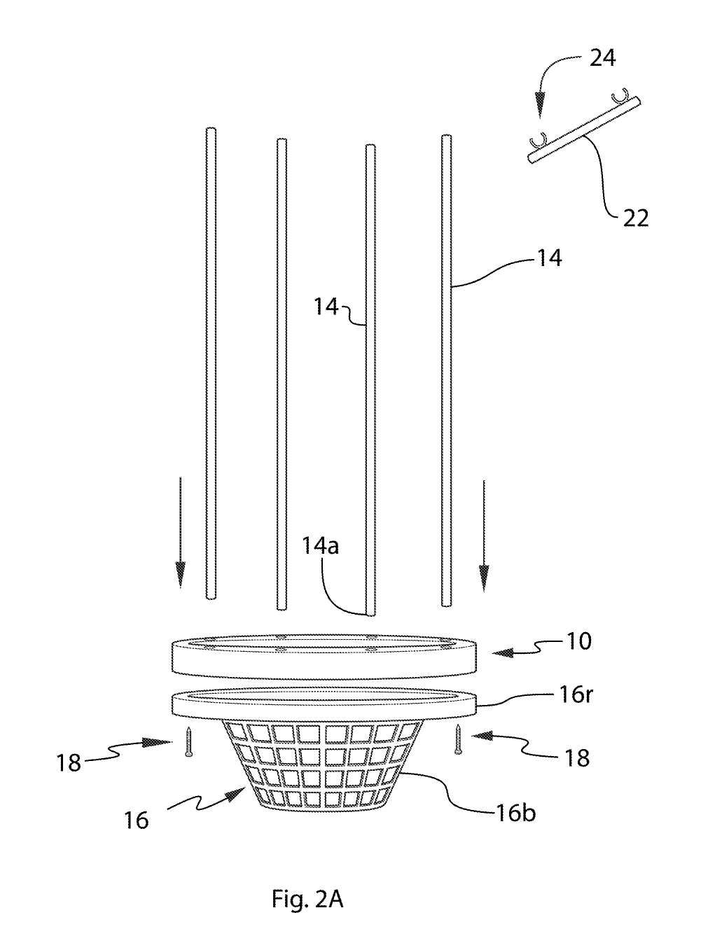

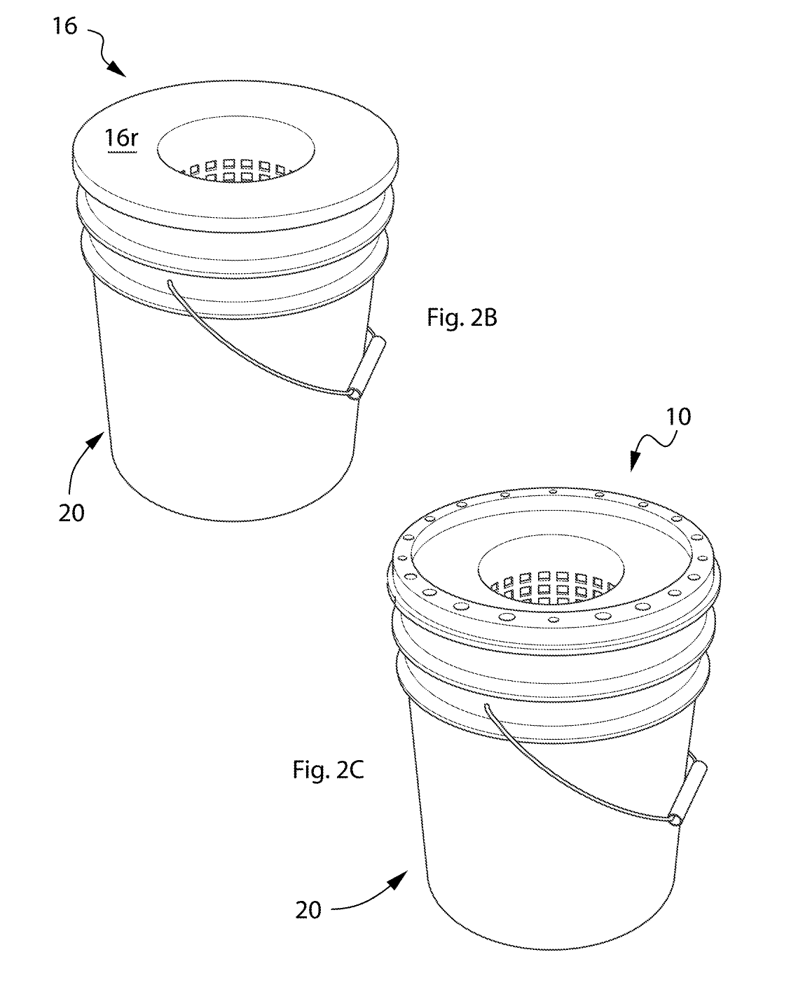

FIG. 2A is an exploded view showing selected components of a trellis system, including the support member 10, a hydroponic modified bucket lid 16 and a plurality of elongated stakes 14. The modified bucket lid 16 is configured and dimensioned to fit on top of, and to be secured to a bucket or container 20 which contains a hydroponic nutrient solution. The modified bucket lid 16 has a relatively wide, flattened annular rim 16r which receives the support member 10 on a radially outer portion thereof, and a flange extending downwardly at the radially outermost portion of the rim for placement around a top edge of a nutrient bucket 20.

FIG. 2A also illustrates a plurality of fastening members 18 for inserting through the annular rim 16r of the modified bucket lid 16 and into the fastening holes 15 of the support member 10, in order to fixedly attach the support member 10 to the outer rim 16r/flattened annular rim 16r of the modified bucket lid 16.

Each of the elongated stakes 14 includes a terminal end portion 14a, which may be inserted into one of the stake support recesses 11 of the support member 10, such that the stakes 14 project substantially vertically upwardly from the support member 10, and are stably supported thereby.

Optionally, if desired, the terminal end portions 14a of the stakes 14 may be provided with male threads thereon, and corresponding female threads may be molded into the recesses 11 to provide a secure fit between the stakes and the support member 10. Other types of connection between the stakes 14 and the recesses 11 may alternatively be used, as will be understood by those in the relevant art.

Hydroponic root ball receptacles 16 are known and commercially available. In similar fashion, buckets such as that shown at 20 are well known and commercially available. As shown in FIGS. 2A-4, the modified bucket lid 16 has a perforated basket 16b formed as an integral central part thereof, the basket being capable of being partly immersed in an associated nutrient reservoir bucket 20, and configured to support one or more plants therein.

If desired, in the practice of the present invention, the support member 10 may be formed together with the modified bucket lid 16 as a unitary plant and stake supporting component of a hydroponic trellis system.

The support member 10 can be formed in any geometric shape, such as, without limitation, circular, semi-circular, oval, square, rectangular, trapezoidal, pentagonal, or rectangular bars, such that it may be appropriately secured to any suitable portion of a growing apparatus.

The diameter of the support member 10 can vary as needed to accommodate standard bucket or modified bucket lid sizes, e.g., the holes and/or recesses 11 may be disposed at a position just outside or just inside of the wall(s) of a bucket or container to which the support member 10 is secured, so that the stakes inserted through the holes will extend closely adjacent to or in contact with the wall(s) of the bucket or container. In one illustrative embodiment, the support member 10 is provided as a substantially annular member having a circular outline shape with an outside diameter in a range between 10-12 inches, in order to be used with a modified bucket lid 16 having a 12 inch diameter and configured to fit on a standard five-gallon bucket 20.

Regardless of the shape or size of the support member 10, it is configured in a size and shape for being secured to or mounted onto portion(s) of a hydroponic system, and it contains the holes and/or recesses 11 in which ends of the elongated stakes 14 could be inserted, such that they extend upwardly from the support member to support the branches or limbs of plants growing in the hydroponic system using ties, string or wire to attach portions of such a plant to the stakes 14.

Although the support member 10 is depicted as a single ring shape, it may include two or more appropriately shaped members that are connected together in spaced relation, e.g., one above the, with holes 11 formed in one or more members that are aligned with holes or recesses 11 formed in the other member(s). Optionally, if desired, the holes and/or recesses 11 may be formed in a recessed portion of the support member 10 for additional strength and stability.

The support member 10 of the invention can be constructed of any appropriate material, including plastic, wood, iron, steel, aluminum, fiberglass, or any other rigid or semi-rigid material. Plastic such as polypropylene, polyethylene, etc. is particularly advantageous because it is relatively inexpensive and can be readily molded into any desired shape. As such, it may be appreciated that the present invention provides an adaptable hydroponic trellis system that can accommodate various sized containers or growth units and provides sturdy, substantially vertical support for the plant's branches and limbs.

Optionally, if desired, horizontal bars 22 may be added between adjacent stakes 14 to join the stakes together and to provide additional support for plant limbs. Where used, such horizontal bars 22 may be made with integral C-shaped clips 24 thereon, in order to facilitate attachment of the bars 22 to the stakes 14.

The support member 10 may be attached to the outside of the bucket 20, or to a modified bucket lid 16 or other hydroponic growing apparatus using self-tapping screws 18 or other fasteners which can be fitted to small openings 15 formed in the support member 10 such as depicted, and which would then penetrate into a suitable portion of the hydroponic system, such as the modified bucket lid 16. The invention is not limited to use of screws 18, but may alternatively use any appropriate fastening means such as bolts, rivets, clamps, ties, glue, frictional snap-fit, magnets, etc.

The most commonly used elongate stakes in conventional trellis systems are wooden dowel stakes/rods, fiberglass stakes/rods, or bamboo stakes/rods, and such conventional stakes may be used as the stakes 14 in the present invention. However, the elongated stakes 14 to be used in conjunction with the support member 10 of the present invention can also be other members such as tubes or poles, hollow or solid, and they can be made of wood, bamboo, fiberglass, plastic, acrylic, metal, or any other appropriate material. The stakes 14 can be round in circumference, diamond-shaped, square, rectangular, hexagonal, or any other geometric shaped as desired.

The use of the trellis system according to the invention allows for easy temporary removal of the modified bucket lid 16 along with the attached support member 10, the stakes 14 and an associated plant (not shown) to permit changing of the nutrient solution in the bucket 20.

A hydroponic trellis system using the support member 10 according to the present invention, together with elongated stakes 14 is not only convenient and reliable to use, but is especially effective at promoting increased yields, while also providing easy plant maintenance and easy access for pruning. The use of the hydroponic trellis system according to the present invention will provide flexibility for plants to expand and develop as needed through each stage of growth. Having the branches and limbs secured to the vertical stakes 14, and optionally the horizontal bars 22, will provide good exposure to incoming light, and will allow for increased airflow and reduced stress in young stems.

As stated, conventional methods of securing hydroponic plants to a supporting structure have failed to meet the needs of the hydroponic farmer because they are too cumbersome and make it difficult to move the plants or access the nutrient liquid reservoir to change the nutrient liquid. Accordingly, there exists today a need for a hydroponics trellis system that allows for the use of elongated stakes similar to the known method used in conventional potted plants grown in dirt or soil. The present invention meets such need.

Although the present invention has been described herein with respect to a present embodiment thereof, the foregoing description may be intended to be illustrative, and not restrictive. Those skilled in the art will realize that many modifications of the present exemplary embodiments could be made which would be operable and would achieve the same advantages as achieved by the exemplary embodiments. All such modifications, as well as equivalents thereof, which are within the scope of the appended claims, are intended to be within the scope and spirit of the present invention.

One possible modification is to form the support member 10 integrally together with a bucket, root ball receptacle, or other appropriate portion of the hydroponic growing system.

Further, although the present invention has particular use in relation to hydroponic plant growing systems, it may also be used in relation to other plant growing systems, including potted plant systems including soil in which the plants are grown.

I claim:

1. An annular support member for use in connection with a hydroponic growing container, said support member having a circular ring shape with a plurality of stake support recesses formed therein and arranged in spaced relation therearound, each of the recesses being configured to supportively receive an end portion of an elongated stake therein.

2. The support member of claim 1, wherein the recesses are formed as blind holes which are closed on the bottom end thereof.

3. The support member of claim 1, wherein the recesses are formed as through holes.

4. The support member of claim 1, wherein the support member also has a plurality of fastening holes formed therein to receive threaded shaft portions of fastening members therein.

5. The support member of claim 1, wherein the support member is formed as a substantially solid member, with the recesses and a plurality of fastening holes formed substantially vertically therethrough.

6. The support member of claim 1, wherein the support member comprises:
a plurality of walls including a substantially vertical radially inner wall, a substantially vertical radially outer wall, and an upper wall interconnecting the inner and outer walls;
a plurality of cylindrical collars, with each of said recesses formed inside one of said cylindrical collars; and
a plurality of reinforcing webs interconnecting each of the cylindrical collars with adjacent portions of the respective walls.

7. A hydroponic plant growing kit comprising a hydroponic modified bucket lid and the support member of claim 1.

8. The hydroponic growing kit of claim 7, further comprising a plurality of stakes for placement in said recesses.

9. A hydroponic plant growing kit comprising a hydroponic modified bucket lid and the support member of claim 6.

10. The hydroponic growing kit of claim 9, further comprising a plurality of stakes for placement in said recesses.

11. A modified hydroponic modified bucket lid configured to fit on top of a hydroponic nutrient reservoir bucket, said modified hydroponic modified bucket lid comprising:
a flattened annular rim;
a perforated basket disposed at a central part of the annular rim, the basket configured to support one or more plants therein,
a flange extending downwardly at a radially outermost portion of the annular rim for placement around a top edge of said nutrient reservoir bucket; and
a support member attached to an upper surface of said annular rim proximate said radially outermost portion, said support member having a circular ring shape with a plurality of stake support recesses formed therein and arranged in spaced relation therearound, each of the recesses being configured to supportively receive an end portion of an elongated stake therein.

12. The modified hydroponic modified bucket lid of claim 11, wherein the recesses of the support member are formed as blind holes which are closed on the bottom end thereof.

13. The modified hydroponic modified bucket lid of claim 11, wherein the recesses are formed as through holes.

14. The modified hydroponic modified bucket lid of claim 11, wherein the support member also has a plurality of fastening holes formed therein to receive threaded shaft portions of fastening members therein.

15. The modified hydroponic modified bucket lid of claim 11, wherein the support member is formed as a substantially solid member, with the recesses and a plurality of fastening holes formed substantially vertically therethrough.

16. The modified hydroponic modified bucket lid of claim 11, wherein the support member comprises:
a plurality of walls including a substantially vertical radially inner wall, a substantially vertical radially outer wall, and an upper wall interconnecting the inner and outer walls;
a plurality of cylindrical collars, with each of said recesses formed inside one of said cylindrical collars; and
a plurality of reinforcing webs interconnecting each of the cylindrical collars with adjacent portions of the respective walls.
